(19) United States
(12) Patent Application Publication
(10) Pub. No.: US 2013/0164644 A1
(43) Pub. Date: Jun. 27, 2013

(54) SYSTEM AND METHOD FOR CONTROLLING PRESSURE OSCILLATION IN ANODE OF FUEL CELL STACK

(71) Applicant: Hyundai Motor Company, Seoul (KR)

(72) Inventors: Yong Gyu Noh, Suwon (KR); Heon Joong Lee, Yongin (KR); Jae Hoon Kim, Suwon (KR)

(73) Assignee: HYUNDAI MOTOR COMPANY, Seoul (KR)

(21) Appl. No.: 13/687,985

(22) Filed: Nov. 28, 2012

(30) Foreign Application Priority Data
Dec. 21, 2011 (KR) 10-2011-0139114

(51) Int. Cl. H01M 8/04

(52) U.S. Cl. CPC H01M 8/04783; H01M 8/04619
USPC 429/431; 429/430

(57) ABSTRACT

Disclosed is a system and method for controlling pressure oscillation in an anode of a fuel cell stack. In particular, an electronic control unit is configured to determine operation information including a reference power mapped based on the operating pressure of a fuel cell system and a reference differential pressure between at least two predetermined points in a vicinity of the anode, compare the power of the fuel cell system with the reference power and, when the power is less than the reference power, control the pressure in the anode to be an oscillating target pressure, and compare the measured differential pressure between the at least two points with the reference differential pressure and, when the measured differential pressure is less than the reference differential pressure, reduce a purge valve operation cycle.

### CROSS-REFERENCE TO RELATED APPLICATION

This application claims under 35 U.S.C. §119(a) the benefit of Korean Patent Application No. 10-2011-0139114 filed Dec. 21, 2011, the entire contents of which are incorporated herein by reference.

### BACKGROUND

(a) Technical Field

The present invention relates to a method for controlling pressure oscillation in an anode of a fuel cell stack. More particularly, the present invention relates to a method for controlling pressure oscillation in an anode of a fuel cell stack, in which an electronic control unit (ECU) controls a target pressure in the anode of the fuel cell stack to periodically oscillate.

(b) Background Art

It has become well accepted that petroleum energy contributes environmental pollution and has limited reserves, and thus extensive research on alternative energy has recently been carried out in most countries to replace or reduce its use. Among them, a fuel cell system using hydrogen energy has been suggested which utilizes a higher thermal efficiency than internal combustion engines, and produces clean by-products thus attracting much attention as excellent alternative energy which is environmentally friendly.

A fuel cell system is a kind of power generation system that converts chemical energy of fuel directly into electrical energy and typically includes a fuel cell stack for generating electricity via electrochemical reaction, a hydrogen supply system for supplying hydrogen as a fuel to the fuel cell stack, an oxygen (air) supply system for supplying oxygen-containing air as an oxidant required for the electrochemical reaction in the fuel cell stack, a thermal management system (TMS) configured to 1) remove reaction heat from the fuel cell stack to outside of the fuel cell system, 2) control the operating temperature of the fuel cell stack, and 3) perform water management functionality. Additionally, most fuel cell systems also include a system controller that is configured to control the overall operation of the fuel cell system.

Conventionally, a hydrogen supply system for the fuel cell system may operate in various manners, for example, as described in Korean Patent No. 10-0836371, Korean Patent Publication No. 10-2011-0029512, etc. and will now be described with reference to FIG. 1A.

Conventional hydrogen supply systems include a hydrogen supply line 12 connected to a hydrogen storage tank 10, a hydrogen recirculation line 14 through which hydrogen unreacted in a fuel cell stack 30 is recirculated, a jet pump 16 mounted between a stack inlet 13 and the hydrogen recirculation line 14 to pump fresh hydrogen and recirculated hydrogen to an anode, a pressure sensor 18 mounted at the stack inlet to measure air and hydrogen pressures, an electronic control unit (ECU) 22 configured to control the flow control operation of a regulator 20 mounted in the hydrogen supply line 12 based on a detection signal from the pressure sensor 18 at the stack inlet, and a purge valve 26 disposed in a discharge line 24 connected to the hydrogen recirculation line 14 to discharge condensed water generated by a reaction between hydrogen and oxygen to the outside of the fuel cell in response to receiving a signal from the ECU 22, etc. Here, the jet pump 16 injects compressed hydrogen supplied from a high-pressure tank through a nozzle to create vacuum and suctions discharge gas from the fuel cell stack 30 using the vacuum, thus recirculating hydrogen gas.

As an ejector that serves to deliver compressed hydrogen and recirculate unreacted hydrogen, a blower 15 may be provided instead of the jet pump 16, as shown in FIG. 1B. In addition, the detection signal of a pressure sensor 28 at a stack outlet may be used by the ECU 22.

Hydrogen ions supplied from the anode meet oxygen ions supplied from a cathode to generate condensed water in the fuel cell stack 30 of the fuel cell system such as a polymer electrolyte membrane fuel cell (PEMFC). The condensed water is typically generated in the cathode and migrates to the anode. This condensed water may interfere with the hydrogen fuel supply, deteriorate the efficiency of the fuel cell stack, and reduce the durability of the fuel cell stack.

In particular, when the jet pump 16 is used, as can be seen from the graph of FIG. 2, which shows the relationship between the power of the fuel cell stack and the operating pressure, the suction efficiency of the jet pump 16 for the hydrogen recirculation is low during a low power operation, and thus it is difficult to discharge the condensed water through the purge valve 26 connected to the hydrogen recirculation line 14.

Moreover, even if the blower 15 is used, when the condensed water of the hydrogen recirculation gas, which may corrode a bearing of the blower and other parts, is discharged through the purge valve 26, the hydrogen unreacted in the fuel cell stack is also discharged. In addition, in the conventional system there is no way to discharge the condensed water without using the purge valve 26.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a system and method for controlling pressure oscillation in an anode of a fuel cell stack, in which an electronic control unit (ECU) controls a target pressure in the anode of the fuel cell stack to periodically oscillate or vibrate in order to effectively control the flow rate of hydrogen supplied, the flow rate of hydrogen recirculated, and the opening and closing of a purge valve during the entire operation of the fuel cell system including low power operations, thus improving fuel efficiency of a fuel cell system overall.

Moreover, the present invention provides a system and method for controlling pressure oscillation in an anode of a fuel cell stack, in which an ECU effectively and efficiently controls a target pressure in the anode of the fuel cell stack by comparing a temperature measured at a predetermined point in a fuel cell system with a reference temperature, thus improving fuel efficiency of the fuel cell system.

In one aspect, the present invention provides a method for controlling pressure oscillation in an anode of a fuel cell stack, the method comprising: determining, at an electronic control unit, operation information including a reference power mapped based on the operating pressure of a fuel cell system and a reference differential pressure between at least two predetermined points in the vicinity of the anode; comparing, at the electronic control unit, the power of the fuel cell system with the reference power and, when the power is lower than the reference power, controlling the pressure in the anode to be an oscillating target pressure; and comparing, at the electronic control unit, the measured differential pressure between the at least two points with the reference differential pressure and, when the measured differential pressure is lower than the reference differential pressure, reducing a purge valve operation cycle.

In another aspect, the present invention provides a method for controlling pressure oscillation in an anode of a fuel cell stack, the method comprising: determining, at an electronic control unit, operation information including a reference power mapped based on the operating pressure of a fuel cell system and a reference temperature at a predetermined point in the fuel cell system; comparing, at the electronic control unit, the power of the fuel cell system with the reference power and, when the power is lower than the reference power, controlling the pressure in the anode to be an oscillating target pressure; and comparing, at the electronic control unit, the temperature measured at the predetermined point with the reference temperature and, when the measured temperature is lower than or equal to the reference temperature, increasing the magnitude of the pressure oscillation.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1A and 1B are schematic diagrams showing a conventional hydrogen supply system for a fuel cell system.

FIG. 2 is a graph showing the relationship between the power of the system and the operating pressure in FIG. 1A.

FIG. 3 is a flowchart illustrating a method for controlling pressure oscillation in an anode of a fuel cell stack in accordance with an exemplary embodiment of the present invention.

FIG. 4 illustrates a method for controlling pressure oscillation in an anode of a fuel cell stack in accordance with an exemplary embodiment of the present invention with respect to the passage of time and schematically shows the internal structure of an ejector.

FIG. 5 is a flowchart illustrating a method for controlling pressure oscillation in an anode of a fuel cell stack in accordance with another exemplary embodiment of the present invention.

FIG. 6 illustrates the method for controlling the pressure oscillation in the anode of the fuel cell stack in accordance with the exemplary embodiments of the present invention with respect to the passage of time.

FIGS. 7A and 7B are graphs illustrating the test results obtained with the method for controlling the pressure oscillation in the anode of the fuel cell stack in accordance with the exemplary embodiment of the present invention.

FIG. 8 is a graph illustrating the test results obtained with and without the method for controlling the pressure oscillation in the anode of the fuel cell stack in accordance with the exemplary embodiment of the present invention.

Reference numerals set forth in the Drawings includes reference to the following elements as further discussed below:

| | |
|---|---|
| 100: hydrogen inlet | 110: nozzle |
| 120: recirculation inlet | 130: mixing zone |
| 140: diffuser | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The below electronic control unit, may be embodied as a controller which includes a processor configured to execute one or more processes and a memory configured to store a plurality of data thereon, or any other device capable of performing one or more processing functions.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Although the below exemplary embodiment is described as using a single electronic control unit to perform the below process, it is understood that the below processes may also be performed by a plurality of controllers or units executing one or more of the below processes.

The above and other features of the invention are discussed infra.

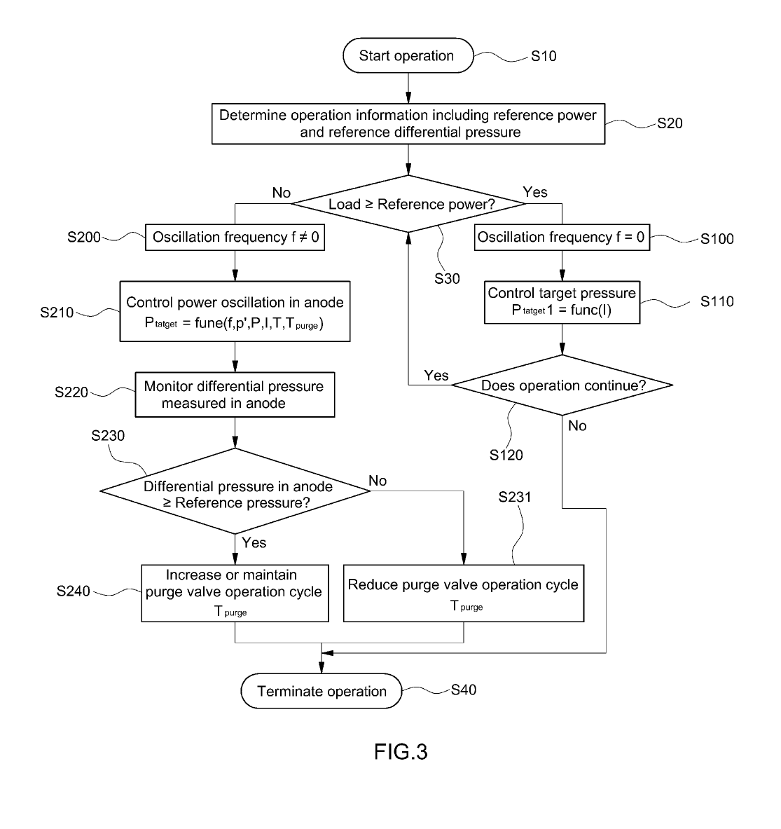

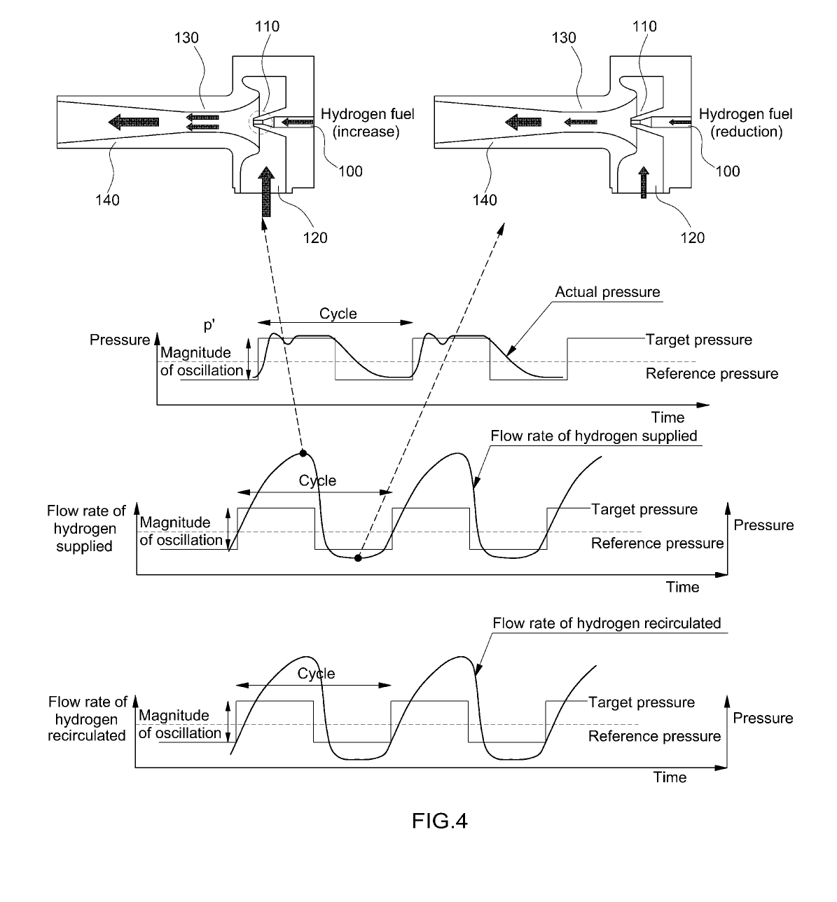

FIG. 3 is a flowchart illustrating a system and method for controlling pressure oscillation in an anode of a fuel cell stack in accordance with an exemplary embodiment of the present invention, and FIG. 4 illustrates a system and method for controlling pressure oscillation in an anode of a fuel cell stack in accordance with an exemplary embodiment of the present invention with respect to the passage of time and schematically shows the internal structure of an ejector.

A method for controlling pressure oscillation in an anode of a fuel cell stack in accordance with an exemplary embodiment of the present invention includes determining, at an electronic control unit (ECU), operation information including a reference power mapped based on the operating pressure of a fuel cell system and a reference differential pressure between at least two predetermined points in the vicinity of the anode; comparing, at the ECU, the power of the fuel cell system with the reference power and, when the power is lower than the reference power, controlling the pressure in the anode to be an oscillating target pressure; and comparing, at the ECU, the measured differential pressure between the at least two points with the reference differential pressure and, when the measured differential pressure is lower than the reference differential pressure, reducing a purge valve operation cycle.

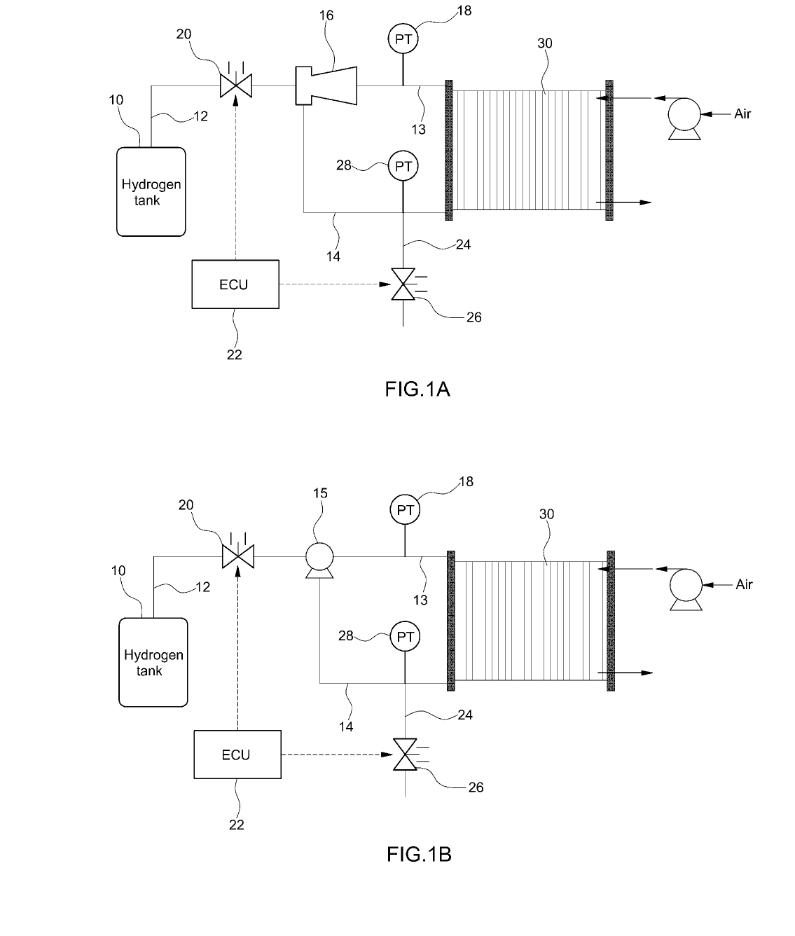

First, the above fuel cell system, a device that supplies hydrogen as fuel to the fuel cell system starts operating (S10). In the present invention, the hydrogen supply system includes a system that employs the jet pump 16 as shown in FIG. 1A and a system that employs the blower 15 as shown in FIG. 1B, as well as a system that is well known, and it is preferable that the electronic control unit, like the ECU 22 shown in FIGS. 1A and 1B, control the entire process of supplying hydrogen.

In particular, the ECU determines operation information including a reference power mapped based on the operating pressure of the fuel cell system and a reference differential pressure between at least two predetermined points in the vicinity of the anode for the purpose of controlling the pressure oscillation in the anode according to the present invention (S20), which is different from the typical control for the fuel cell system. In particular, the mapping may be generated so that the differential pressure in the anode or the flow rate of hydrogen recirculated is at its maximum, the reference power and the reference differential pressure are closely related to the operating pressure of the fuel cell system, and the operation information including the reference power and the reference differential pressure may be prepared based on existing operating data. Here, the at least two predetermined points are preferably an inlet and an outlet of the anode, but are not limited to those two particular points.

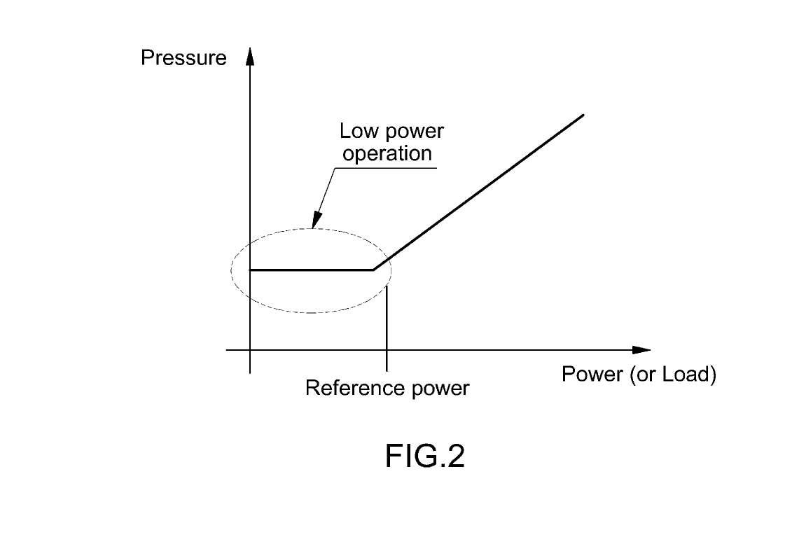

Continuously, the ECU monitors the power or load of the fuel cell system and compares the power or load with the reference power at regular intervals or in real time (S30). When the power of the fuel cell system is greater than or equal to the reference power, the ECU determines that a sufficient amount of fuel is injected into the anode of the fuel cell stack and sets an oscillation frequency f to 0 as shown in FIG. 2 (S100). As the oscillation frequency f is set to 0, variables other than current I flowing through the fuel cell stack are 0, and the ECU establishes an Equation that controls a target pressure P_{target1} in the anode as follows (S110).

P_{target}_{₁}=func(I) [Equation1]

That is, the ECU determines the target pressure in the anode only based on the current flowing through the fuel cell stack. Accordingly, the current I has a proportional relationship with the power of the fuel cell system.

Then, the ECU determines whether a signal indicating that the system operates continuously is applied (S120) and, when the system operates continuously, compares the output of the fuel cell system with the reference power again (S30). As a result, when the power of the fuel cell system is greater than or equal to the reference power, the ECU repeats the above operation (S100) and, if not, performs subsequent operations (S200). Otherwise, the ECU receives an operation termination signal and turns off the fuel cell system (S40).

Meanwhile, when the power of the fuel cell system is less than the reference power, the ECU controls the pressure in the anode to be an oscillating target pressure. Here, as shown in FIG. 2, the ECU determines that the fuel cell system is in a low power operation state and sets the oscillation frequency f to a value other than 0 (S200). At the same time, the ECU controls a target pressure P_{target2} in the anode to be determined based on the following Equation 2 (S210).

P_{target}_{₂}=func(f,p′,P,I,T,T_{purge}) [Equation 2]

That is, the ECU controls the target pressure in the anode to be determined by functions of parameters such as the oscillation frequency f, oscillation magnitude p′, reference pressure (average pressure) P mapped based on the operating power or operating load, current I flowing through the fuel cell stack, operating temperature T of the fuel cell stack, and purge valve operation cycle T_{purge}. Here, the target pressure and the reference pressure may be measured by the pressure sensor 18 shown in FIGS. 1A and 1B, but the pressure sensor 18 should be installed at the inlet side of the anode to measure the pressures. In addition, the operating temperature T may be a coolant temperature, a recirculation hydrogen gas temperature, an air temperature, etc.

When the ECU controls the target pressure P_{target2} in the anode to periodically fluctuate based on the above Equation, a flow rate control valve 20 or regulator that controls the flow rate of hydrogen supplied operates based on the target pressure as shown in FIGS. 1A and 1B.

As shown in FIG. 4, the hydrogen passing through the flow rate control valve, which is opened and closed by a signal transmitted from the ECU, is delivered to an ejector through an inlet 100. The compressed hydrogen is injected through a nozzle 110 and mixed with hydrogen introduced through a recirculation inlet 120 in a mixing zone 130. A diffuser 140 delivers the mixed hydrogen to the anode of the fuel cell stack. Here, the flow rate control valve operates based on the target pressure, and thus the flow rate of hydrogen passing through the nozzle 110 is periodically increased or decreased.

In particular, during the increase in the flow rate of hydrogen, the unsteady flow of the nozzle 110 increases the vacuum in the nozzle 110 and further facilitates the mixing of hydrogen and suctions gas in the mixing zone 130 and the diffuser 140, thus increasing the flow rate of hydrogen recirculated. The increase in the flow rate of hydrogen recirculated may increase the purge valve operation cycle P_{purge}, and thus the amount of unreacted gas discharged to outside the system through the purge valve can be reduced.

The changes in the flow rate of hydrogen supplied and the flow rate of hydrogen recirculated according to the change in the target pressure in the anode will now be described in detail with reference to the graphs in FIG. 4. As shown in the first graph of FIG. 4, the target pressure changes at each frequency f (the reciprocal of the period) with the oscillation magnitude p′ with respect to the reference pressure in the anode. The target pressure is determined by additional parameters such as the reference pressure P mapped based on the operating load, the current I, the operating temperature T, the purge valve operation cycle T_{purge}, etc. as well as p′ and f. When the ECU controls the pressure oscillation in the anode, the actual pressure changes with a predetermined tolerance based on the target pressure.

As shown in the second and third graphs of FIG. 4, when the ECU controls the target pressure in the anode to oscillate, the flow rate of hydrogen supplied is changed by the opening and closing of the flow rate control valve based on the target pressure, and the maximum value of the differential pressure between the inlet and the outlet of the anode also changes. Here, the differential pressure between the inlet and the outlet of the anode is related to the flow rate of hydrogen recirculated.

Point □ in the second graph of FIG. 4 is related to the left schematic diagram of the ejector, and point □ is related to the right schematic diagram of the ejector.

At point □, the amount of hydrogen introduced through the inlet 100 increases, and thus the amount of compressed hydrogen passing through the nozzle 110 also increases. As a result, it can be seen that the flow rate of hydrogen introduced into the anode and the flow rate of hydrogen recirculated through the recirculation inlet 120 increase.

Moreover, at point □, the amount of hydrogen introduced through the inlet 100 is reduced, and thus the amount of compressed hydrogen passing through the nozzle 110 is also reduced. As a result, it can be seen that the flow rate of hydrogen introduced into the anode and the flow rate of hydrogen recirculated through the recirculation inlet 120 are reduced.

As such, when the flow rate of hydrogen recirculated increases, the length of purge valve operation cycle increases, and thus the amount of hydrogen discharged to the outside can be reduced. In addition, the pressure oscillations at the inlet and the outlet of the anode and the flow rate pulse can increase the amount of condensed water discharged from the fuel cell stack, and thus the number of purge valve operation cycles required can be reduced.

Subsequently, the ECU monitors the differential pressure measured at least two predetermined points in the anode of the fuel cell stack (S220). Here, it is preferable that the measured differential pressure between the two predetermined points is a difference between the inlet pressure of the anode and the outlet pressure of the anode, and the differential pressure is calculated by the ECU. Then, the ECU compares the monitoring result of the differential pressure in the anode with the reference pressure at regular intervals or in real time (S230).

When the differential pressure measured in this manner is less than the reference differential pressure, the ECU determines that the flow rate of hydrogen recirculated is insufficient and reduces the purge valve operation cycle T_{purge} (S231). The reduction in the purge valve operation cycle T_{purge} indicates that the purge valve is more frequently opened and closed, which may increase the amount of condensed water discharged and the flow rate of hydrogen recirculated.

Contrary to this, when the measured differential pressure is greater than or equal to the reference differential pressure, the ECU determines that the flow rate of hydrogen recirculated is sufficient or excessive and increases the purge valve operation cycle T_{purge} (S232). The increase in the purge valve operation cycle T_{purge} indicates that the purge valve is less frequently opened and closed, which may reduce the amount of condensed water discharged and reduces or maintains the flow rate of hydrogen recirculated. In response, the ECU compares the power of the fuel cell system with the reference power again (S30) and repeats the above operation (S200) or sets the oscillation frequency f to 0 (S100). Otherwise, the ECU receives an operation termination signal and turns off the fuel cell system (S40).

As such, according to the system and method for controlling the pressure oscillation in the anode of the fuel cell stack in accordance with an exemplary embodiment of the present invention, the target pressure in the anode is controlled by the ECU, and thus it is possible to control the flow rate of hydrogen supplied and the flow rate of hydrogen recirculated by controlling the opening and closing of the flow rate control valve and the purge valve, thus improving the efficiency of the entire fuel cell system and the fuel efficiency and durability of the fuel cell stack.

In the above exemplary embodiment, the output of the fuel cell system may be compared with the reference power and, when the output of the fuel cell system is lower than the reference power, the electronic control unit controls the pressure in the anode to be an oscillating target pressure. However, although not shown in the figures, even when the measured differential pressure is less than the reference differential pressure, the electronic control unit may control the pressure in the anode to be an oscillating target pressure.

When the amount of hydrogen supplied to the jet pump (ejector) is high, the amount of hydrogen recirculated in the fuel cell stack increases, and thus the differential pressure between the inlet and the outlet of the anode increases as well. Accordingly, it is determined whether to perform the pressure oscillation control of controlling the pressure in the anode to be an oscillating target pressure based on the measured differential pressure between the at least two points (e.g., the pressure oscillation control is performed when the measured differential pressure is less than the reference differential pressure). As such, even when the measured differential pressure is lower than the reference differential pressure, it is possible to control the pressure in the anode to be an oscillating target pressure (pressure oscillation control) and, at the same time, since the measured differential pressure is less than the reference differential pressure, the electronic control unit controls the purge valve operation cycle to be reduced. Of course, even in this case, the target pressure P_{target2} may be set to be determined by Equation 2 as mentioned above.

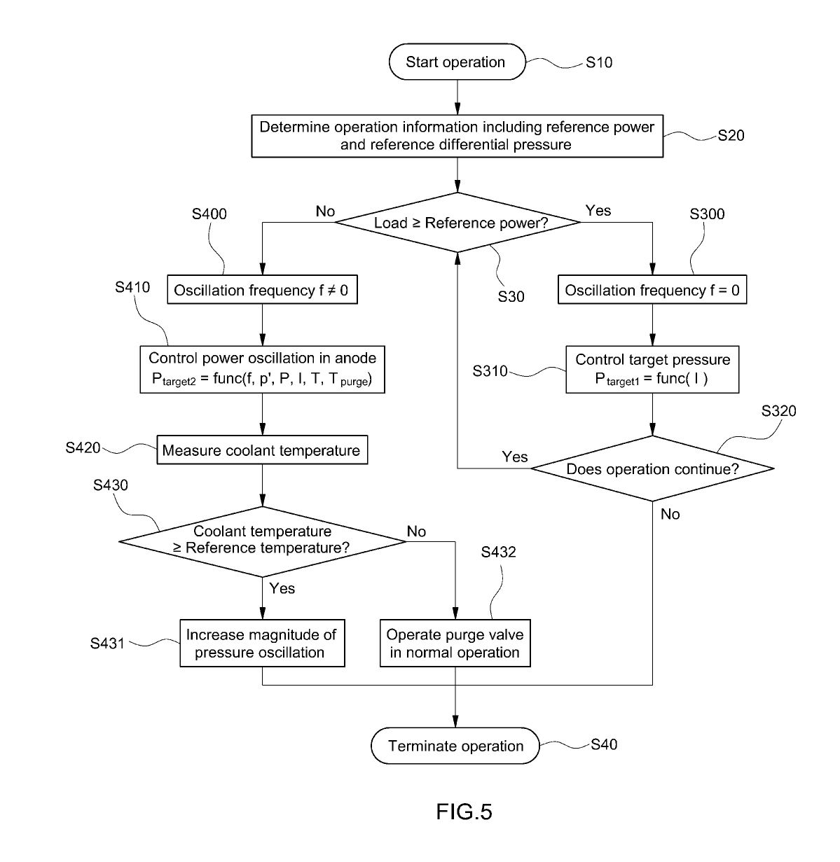

Meanwhile, a method for controlling pressure oscillation in an anode of a fuel cell stack in accordance with another exemplary embodiment of the present invention includes determining, at an electronic control unit (ECU), operation information including a reference power mapped based on the operating pressure of a fuel cell system and a reference temperature at a predetermined point in the fuel cell system; comparing, at the ECU, the power of the fuel cell system with the reference power and, when the power is lower than the reference power, controlling the pressure in the anode to be an oscillating target pressure; and comparing, at the ECU, the temperature measured at the predetermined point with the reference temperature and, when the measured temperature is lower than or equal to the reference temperature, increasing the magnitude of the pressure oscillation. In this regard, FIG. 5 illustrates a method for controlling pressure oscillation in an anode of a fuel cell stack in accordance with another exemplary embodiment of the present invention.

First, in the fuel cell system, a device that supplies hydrogen as fuel to the fuel cell system starts operating (S10). Then, the ECU determines operation information including a reference power mapped based on the operating pressure of the fuel cell system and a reference temperature at a predetermined point in the fuel cell system for the purpose of controlling the pressure oscillation in the anode according to the present invention (S20), which is different from the typical control for the fuel cell system.

The mapping may be made such that the differential pressure in the anode or the flow rate of hydrogen recirculated is at its maximum, the reference power and the reference temperature are closely related to the operating pressure of the fuel cell system, and the operation information including the reference power and the reference temperature may be prepared based on existing operating data. Here, the predetermined point at which the reference temperature is measured is preferably a coolant line, an inlet or an outlet of the anode, but is not limited to a particular point.

Continuously, the ECU monitors the power or load of the fuel cell system and compares the power or load with the reference power at regular intervals or in real time (S30). When the power of the fuel cell system is greater than or equal to the reference power, the ECU determines that a sufficient amount of fuel is injected into the anode of the fuel cell stack and sets an oscillation frequency f to 0 (S300). As the oscillation frequency f is set to 0, variables other than current I flowing through the fuel cell stack are 0, and the ECU establishes an Equation that controls a target pressure P_{target1} in the anode as the above-described Equation 1.

Then, the ECU determines whether a signal indicating that the system operates continuously is applied (S320) and, when the system operates continuously, compares the output of the fuel cell system with the reference power again (S30). As a result, when the power of the fuel cell system is greater than or equal to the reference power, the ECU repeats the above operation (S300) and, if not, performs the following operation (S400). Otherwise, the ECU receives an operation termination signal and turns off the fuel cell system (S40).

Meanwhile, when the power of the fuel cell system is less than the reference power, the ECU controls the pressure in the anode to be an oscillating target pressure. Here, as shown in FIG. 2, the ECU determines that the fuel cell system is in a low power operation state and sets the oscillation frequency f to a value other than 0 (S400). At the same time, the ECU controls a target pressure P_{target2} in the anode to be determined based on the above-described Equation 2 (410). When the ECU controls the target pressure P_{target2} in the anode to periodically fluctuate based on Equation 2, a flow rate control valve 20 or regulator that controls the flow rate of hydrogen supplied operates based on the target pressure as shown in FIGS. 1A and 1B.

In the method for controlling the pressure oscillation in the anode of the fuel cell stack in accordance with another exemplary embodiment of the present invention, the controlling of the target pressure P_{target2} is performed in the same manner as the control method in accordance with an exemplary embodiment of the present invention, and thus a detailed description thereof will be omitted.

Then, the ECU monitors the temperature measured at the predetermined point in fuel cell system (S420). Here, the temperature measured at the predetermined point is measured at the same point as the reference temperature, and the predetermined point at which the reference temperature is measured is preferably a coolant line, an inlet or an outlet of the anode, but is not limited to a particular point. It should be noted, however, that the anode is not necessarily limited to air or hydrogen and the temperature may be calculated by the ECU. In response to these measurements, the ECU compares the monitoring result of the measured temperature with the reference temperature at regular intervals or in real time (S430).

When the temperature measured in this manner is less than or equal to the reference temperature, the ECU increases the magnitude of the pressure oscillation (S431). That is, as the magnitude of the pressure oscillation is increased, for example, by the variable T in the above Equation 2, it is possible to effectively discharge condensed water, which is unnecessarily generated in the fuel cell system that has not reached an optimal operating temperature (e.g., about 55 to 70° C.) during initial startup or under low temperature conditions during winter season, without the operation of the purge valve.

Contrary to this, when the measured temperature is greater than the reference temperature, the ECU may operate the purge valve at regular intervals (S432). Here, it is preferable that when the predetermined point at which the temperature is measured is the coolant line, the reference temperature be set to about 40° C.

Then, the ECU compares the power of the fuel cell system with the reference power again (S30) and repeats the above operation (S400) or sets the oscillation frequency f to 0 (S300). Otherwise, the ECU receives an operation termination signal and turns off the fuel cell system (S40).

As such, according to the method for controlling the pressure oscillation in the anode of the fuel cell stack in accordance with another exemplary embodiment of the present invention, the target pressure in the anode is controlled by the ECU, and thus it is possible to effectively discharge condensed water, which is unnecessarily generated in the anode during initial startup or under low temperature conditions during, e.g., winter temperatures, without the operation of the purge valve, thus improving the efficiency of the entire fuel cell system and the fuel efficiency and durability of the fuel cell stack.

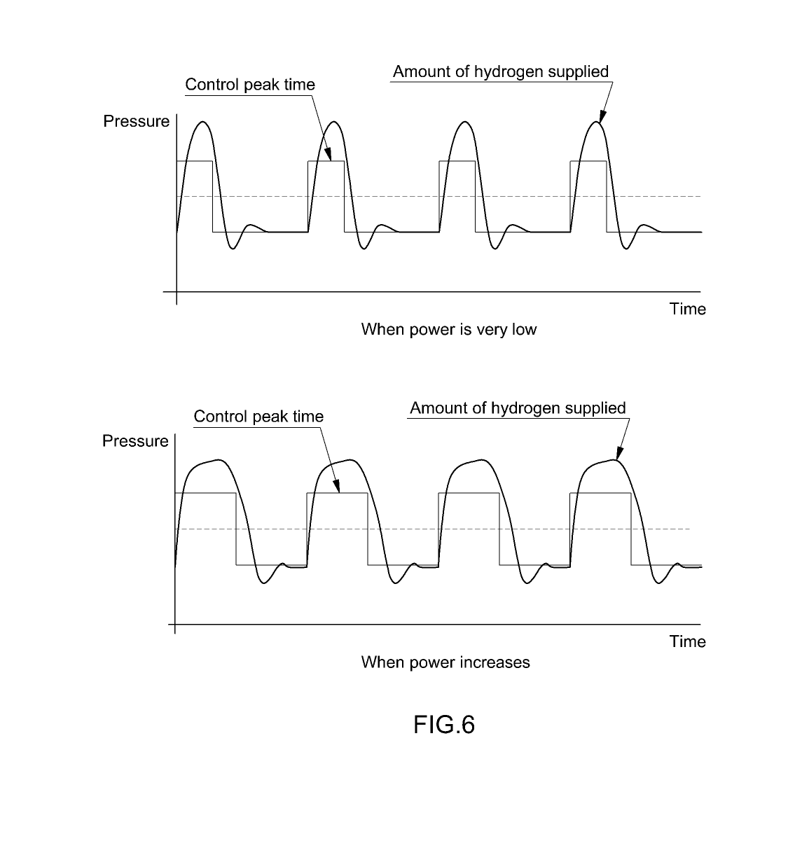

In each of the above-described embodiments according to the present invention, the ECU may simultaneously control the target pressure in the anode to change as shown in FIG. 6. FIG. 6 shows the method for controlling the pressure oscillation in the anode of the fuel cell stack in accordance with the exemplary embodiments of the present invention with respect to the passage of time.

In order for the target pressure to be set by controlling the pressure oscillation in the anode if the power of the fuel cell system is less than the reference power, when an oscillation cycle 1/f, which is related to the oscillation frequency f, one of the parameters that determines the target pressure, is controlled, the peak time in the oscillation cycle may be changed based on the operating power.

When the power or load of the fuel cell system is very low, however, the ECU controls the peak time to be reduced when controlling the change of the target pressure. That is, the peak time in one cycle is reduced by controlling the duty as shown in the top portion of the graph in FIG. 6, and thus it is possible to manage the pressure drop due to hydrogen consumption to within an appropriate level and effectively increase the flow rate of hydrogen supplied when the target pressure increases later on.

Furthermore, when the power or load of the fuel cell system is relatively high, the ECU controls the peak time to be increased when controlling the change of the target pressure. That is, the peak time in one cycle is increased by controlling the duty as shown in the bottom graph of FIG. 6, and thus it is possible to control the flow rate of hydrogen supplied to increase more smoothly.

### Test Examples

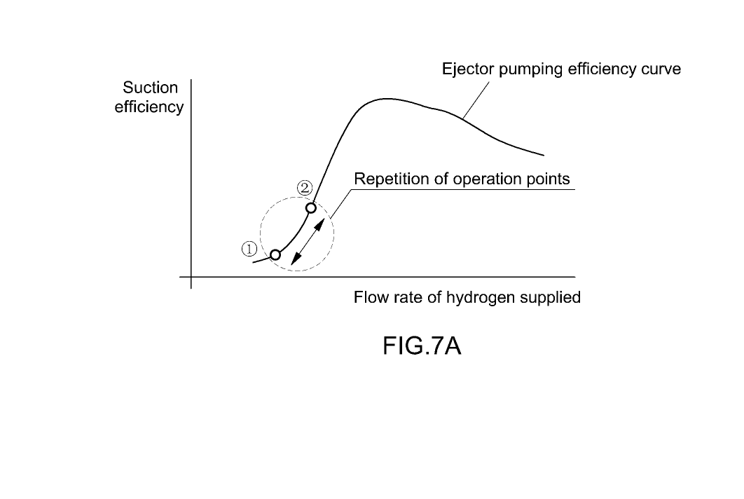

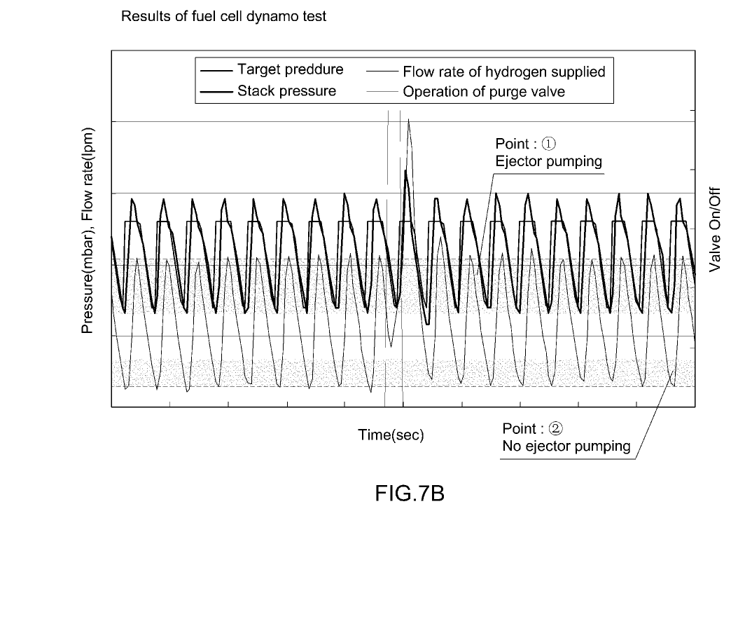

FIG. 7A is a graph illustrating a pumping efficiency curve when the method for controlling the pressure oscillation in the anode of the fuel cell stack in accordance with an exemplary embodiment of the present invention is applied to the ejector-type hydrogen supply system and illustrates the change in suction efficiency based on the change in the flow rate of hydrogen supplied. In particular, the changes in the suction efficiency and the flow rate of hydrogen supplied at points 1 and 2 will be described with reference to FIG. 7B.

FIG. 7B is a graph showing the target pressure, the changes in the actual pressure in the fuel cell stack and the flow rate of hydrogen supplied, and the purge valve operation timing with respect to the passage of time in the fuel cell system to which the method for controlling the pressure oscillation in the anode of the fuel cell stack in accordance with an exemplary embodiment of the present invention is applied.

According to the present invention, when the ECU controls the oscillation frequency f to be a value other than 0, the target pressure is periodically changed as shown in FIG. 7B. That is, the ECU controls the pressure in the anode of the fuel cell stack to periodically oscillate or vibrate, like the target pressure. Of course, there may be a certain difference between the target pressure and the actual pressure in the stack. It can be seen that the flow rate of hydrogen supplied changes based on the target pressure or actual pressure and the flow rate of hydrogen supplied rapidly increases at the purge valve operation cycle. Thus, it can be seen that the flow rate of hydrogen supplied can be controlled by controlling the purge valve operation cycle.

Moreover, at point 2 shown in FIG. 7B, when there is no pumping of the ejector, the suction efficiency is relatively low as can be seen from FIG. 6A. However, at point 1, where the pumping of the ejector occurs, the suction efficiency is relatively high. The average value of the suction efficiency is greater than the suction efficiency during the operation as the oscillation frequency f is set to 9 during the entire operation, from which it can be seen that the fuel cell system to which the control method of the present invention is applied is more effective.

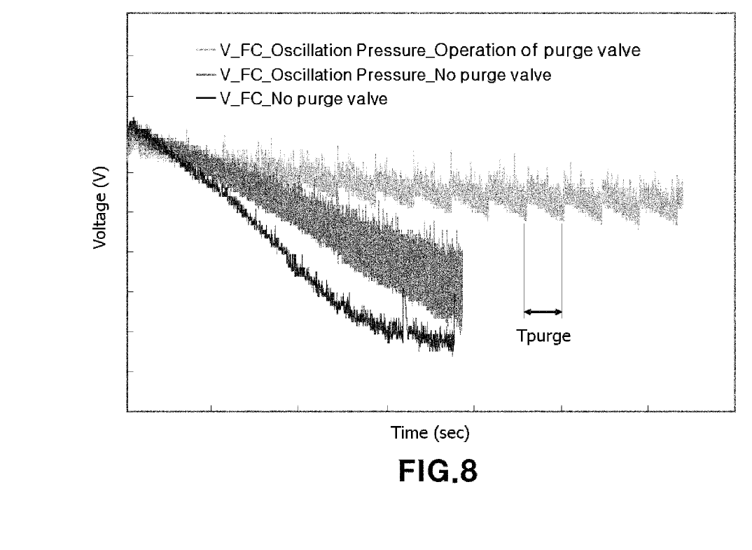

FIG. 8 is a graph illustrating the test results obtained with and without the method for controlling the pressure oscillation in the anode of the fuel cell stack in accordance with the exemplary embodiment of the present invention. The test was performed to determine the effect of the control of the pressure oscillation, in which the voltage drop occurring with the passage of time in a state where a constant load current and a reference pressure were applied was measured, and the effects were compared.

The graph shows the results of the test without the control of the pressure oscillation in the anode and without the use of the purge valve, from which it can be seen that many voltage drops occurred for a relatively short time. Moreover, the graph shows the results of the test with the control of the pressure oscillation in the anode and without the use of the purge valve, from which it can be seen that the range of fluctuation was excessive together with significant voltage drops for the same time as the above test, and it can be said that the cause of the performance degradation is the absence of the smooth discharge of produced condensed water.

On the contrary, the graph shows the results of the test obtained by applying the method for controlling the pressure oscillation in the anode of the fuel cell stack in accordance with the exemplary embodiment of the present invention, from which it can be seen that no voltage drop occurred even though the test was performed for a time longer than about two times that of the above tests. In addition, it can be seen that when the purge valve is opened and closed at each purge valve operation cycle T_{purge}, the voltage increases to a predetermined level.

As such, when the pressure in the anode is controlled to fluctuate, like in each of the above-described embodiments according to the present invention, it is possible to maintain a high degree of efficiency during the entire operation of the fuel cell system and improve the fuel efficiency and durability of the fuel cell stack in order to the increase a stoichiometric ratio (SR). An SR is defined as the ratio of the amount of hydrogen supplied to the amount of hydrogen required for the generation of electricity in the fuel cell stack. As the SR increases, it is possible to increase the flow rate of hydrogen in fine channels of the anode, uniformize the flow of hydrogen in the channels, facilitate the discharge of condensed water and other gases, and reduce the difference in the temperature, humidity, etc. between the inlet and the output of the fuel cell stack.

As described above, according to the system method for controlling the pressure oscillation in the anode of the fuel cell stack in accordance with the exemplary embodiments of the present invention, it is possible to increase the operation cycle of the purge valve by more than 3 to 4 times, and thus it is possible to reduce the amount of unreacted hydrogen, which is discharged to the outside, thus improving the fuel efficiency.

Moreover, when the present invention is applied to the fuel cell system equipped with an ejector causing a pumping action, it is possible prevent degradation in suction performance during low power operations and facilitate the mixing of hydrogen gases in the mixing zone by temporarily increasing the flow rate of hydrogen supplied, thus improving the pumping performance and increasing the stoichiometric ratio (SR).

Furthermore, according to the system and method for controlling the pressure oscillation in the anode of the fuel cell stack in accordance with another exemplary embodiment of the present invention, it is possible to discharge the condensed water, which is generated until the fuel cell system reaches an optimal operating temperature, without the use of the purge valve by increasing the magnitude of the pressure, thus reducing the voltage drop in the fuel cell stack, increasing the efficiency of the fuel cell stack, and improving the durability of the fuel cell stack.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for controlling pressure oscillation in an anode of a fuel cell stack, the method comprising:
determining, at an electronic control unit, operation information including a reference power mapped based on the operating pressure of a fuel cell system and a reference differential pressure between at least two predetermined points in a vicinity of the anode;
comparing, at the electronic control unit, the power of the fuel cell system with the reference power and, when the power is less than the reference power, controlling the pressure in the anode to be an oscillating target pressure; and
comparing, at the electronic control unit, the measured differential pressure between the at least two points with the reference differential pressure and, when the measured differential pressure is less than the reference differential pressure, reducing a purge valve operation cycle.

2. The method of claim 1, wherein while comparing the measured differential pressure, the electronic control unit controls the purge valve operation cycle to increase when the measured differential pressure is greater than the reference differential pressure, and controls the purge valve operation cycle to be maintained when the measured differential pressure is less than or equal to the reference differential pressure.

3. The method of claim 1, wherein the at least two points are an inlet and an outlet of the anode.

4. The method of claim 1, further comprising comparing the measured differential pressure between the at least two points with the reference differential pressure and, when the measured differential pressure is less than the reference differential pressure, controlling, at the electronic control unit, the pressure in the anode to be an oscillating target pressure and, at the same time, reducing, at the electronic control unit, the purge valve operation cycle.

5. The method of claim 1, wherein in the second step, the target pressure is determined by functions of parameters such as oscillation frequency f, oscillation magnitude p′, reference pressure P in the anode mapped based on the operating power, current I flowing through the fuel cell stack, operating temperature T of the fuel cell stack, and purge valve operation cycle T_{purge}.

6. The method of claim 1, wherein the electronic control unit controls the pressure in the anode to be determined by the current I flowing through the fuel cell stack if the power is higher than the reference power.

7. A method for controlling pressure oscillation in an anode of a fuel cell stack, the method comprising:
determining, at an electronic control unit, operation information including a reference power mapped based on the operating pressure of a fuel cell system and a reference temperature at a predetermined point in the fuel cell system;
comparing, at the electronic control unit, the power of the fuel cell system with the reference power and, when the power is less than the reference power, controlling the pressure in the anode to be an oscillating target pressure; and
comparing, at the electronic control unit, the temperature measured at the predetermined point with the reference temperature and, when the measured temperature is less than or equal to the reference temperature, increasing the magnitude of the pressure oscillation.

8. The method of claim 7, wherein the electronic control unit operates a purge valve at regular intervals when the measured temperature is greater than the reference temperature.

9. The method of claim 7, wherein the predetermined point is a coolant line, an inlet or an outlet of the anode.

10. The method of claim 7, wherein the target pressure is determined by functions of parameters such as oscillation frequency f, oscillation magnitude p′, reference pressure P in the anode mapped based on the operating power, current I flowing through the fuel cell stack, operating temperature T of the fuel cell stack, and purge valve operation cycle T_{purge}.

11. The method of claim 7, wherein, the electronic control unit controls the pressure in the anode to be determined by the current I flowing through the fuel cell stack if the power is higher than the reference power.

12. The method of claim 8, wherein when an oscillation cycle, which is related to the oscillation frequency f, is controlled, a peak time in the oscillation cycle is changed based on the operating power.

13. A non-transitory computer readable medium for controlling pressure oscillation in an anode of a fuel cell stack, the non-transitory-computer readable medium containing program instructions executed by a controller, the computer readable medium comprising:
program instructions that determine operation information including a reference power mapped based on the operating pressure of a fuel cell system and a reference temperature at a predetermined point in the fuel cell system;
program instructions that compare the power of the fuel cell system with the reference power and, when the power is less than the reference power, control the pressure in the anode to be an oscillating target pressure; and
program instructions that compare the temperature measured at the predetermined point with the reference temperature and, when the measured temperature is less than or equal to the reference temperature, increase the magnitude of the pressure oscillation.

12. A non-transitory computer readable medium for controlling pressure oscillation in an anode of a fuel cell stack, the non-transitory-computer readable medium containing program instructions executed by a controller, the computer readable medium comprising:
program instruction that determine operation information including a reference power mapped based on the operating pressure of a fuel cell system and a reference differential pressure between at least two predetermined points in a vicinity of the anode;
program instruction that compare the power of the fuel cell system with the reference power and, when the power is less than the reference power, control the pressure in the anode to be an oscillating target pressure; and
program instruction that compare the measured differential pressure between the at least two points with the reference differential pressure and, when the measured differential pressure is less than the reference differential pressure, reduce a purge valve operation cycle.
